(19) United States
(12) Patent Application Publication
(10) Pub. No.: US 2016/0215677 A1
(43) Pub. Date: Jul. 28, 2016

(54) CYLINDER HEAD AND METHOD OF MANUFACTURING CYLINDER HEAD

(71) Applicant: TOYOTA JIDOSHA KABUSHIKI KAISHA, Toyota-shi (JP)

(72) Inventor: Satoko TOFUKUJI, Minato-ku (JP)

(73) Assignee: TOYOTA JIDOSHA KABUSHIKI KAISHA, Toyota-shi (JP)

(21) Appl. No.: 15/001,527

(22) Filed: Jan. 20, 2016

(30) Foreign Application Priority Data
Jan. 26, 2015 (JP) 2015-012240

(51) Int. Cl. F01P 3/14; F01P 3/02; F02F 1/10

(52) U.S. Cl. CPC F01P 3/14; F02F 1/10; F01P 3/02; F01P 2003/024

(57) ABSTRACT

A cooling water channel core that is used for casting of the cylinder head includes a core body for obtaining a channel that passes through the periphery of a plurality of intake valve insertion holes, and a core print that is integrally formed with the core body at a location that is between an adjacent two combustion chambers of the core body and that comes in contact with an outer casting mold in a casting mold manufacturing step. When the cooling water channel core is arranged inside the outer casting mold and casting is performed, a cylinder head is manufactured that has an opening portion that opens in an outer face from the cooling water channel. The opening portion is sealed by a sealing plug after being utilized for sand extraction and inspection.

### BACKGROUND

1. Field of the Application

The present application relates to a cylinder head of an internal combustion engine and a method of manufacturing a cylinder head, and more particularly relates to a cylinder head that includes therein a channel through which cooling water flows and a method of manufacturing the cylinder head.

2. Background Art

A channel through which cooling water flows is formed in a cylinder head of an internal combustion engine. In Japanese Patent Laid-Open No. 2013-133746 a configuration is disclosed in which, in order to adequately cool air inside an intake port, a first cooling water circuit through which cooling water for cooling the periphery of an intake port circulates independently from a second cooling water circuit through which cooling water for cooling the periphery of an exhaust port circulates inside a cylinder block and a cylinder head.

The first cooling water circuit includes an intake-port cooling water passage that is formed in the cylinder head. One end of the intake-port cooling water passage is connected to a cooling water introduction portion that is provided in an end face in a width direction of the cylinder head. The intake-port cooling water passage runs from the cooling water introduction portion through the periphery of an intake port, and the other end thereof is connected to a cooling water lead-out portion that is provided in an end face in a longitudinal direction of the cylinder head. According to this configuration of such a cooling water passage of a cylinder head, the periphery of an intake port can be cooled independently of other areas.

### SUMMARY OF THE APPLICATION

A method that employs cast molding using a core is generally used as a method of manufacturing a cylinder head. As described in the aforementioned convention technology, in the case of a cylinder head in which a cooling water passage is formed for independently cooling the periphery of an intake port, cast molding is performed after a core that is molded in the shape of the cooling water passage is arranged inside a casting mold. In many cases a core for forming a cooling water passage that passes through the periphery of an intake valve insertion hole among an area at the periphery of an intake port has an elongated intricate shape because of constraints relating to the structure thereof. In the case of such a cooling water passage shape, there is a risk that displacement or warping of the core will occur when casting. Therefore, as a measure to counter the occurrence of a displacement of the cooling water passage due to such a casting defect, it is conceivable to secure a margin with respect to a clearance with other adjoining spaces in advance. However, a problem in this case where such a measure is adopted is that the cooling efficiency will decrease.

Further, when performing casting that uses a core having an elongated intricate shape as described above, there is a problem that blockage of the channel due to residual sand of the core or a casting defect caused by retention of gas at the time of casting is liable to occur, and also that it is difficult to perform an inspection of the cooling water passage.

The present application has been made in view of the above-described problems, and an object of an embodiment of the present application is, in the case of manufacturing a cylinder head in which a cooling water passage that passes through the periphery of an intake valve insertion hole is formed, to provide a method for manufacturing a cylinder head that suppresses the occurrence of casting defects and manufactures a cylinder head that has excellent cooling efficiency.

A further object of an embodiment of the present application is, with respect to a cylinder head in which a cooling water passage that passes through the periphery of an intake valve insertion hole is formed, to provide a cylinder head that allows inspection of the cooling water passage to be performed with ease.

To achieve the above described objects, a first disclosure is a cylinder head for a multi-cylinder engine that includes: a plurality of combustion chambers that are provided side by side in a longitudinal direction of the cylinder head, a plurality of intake valve insertion holes that are provided for each of the plurality of combustion chambers, and a cooling water channel that passes through a periphery of the plurality of intake valve insertion holes and extends in the longitudinal direction. In at least one cross section among cross sections that are perpendicular to the longitudinal direction between two adjacent combustion chambers, the cylinder head includes an opening portion that opens in a face on an opposite side to a cylinder block mating face of the cylinder head from the cooling water channel.

A second disclosure is in accordance with the first disclosure, wherein the opening portion is sealed by a sealing plug.

A third disclosure is in accordance with the second disclosure, wherein the sealing plug is configured to seal the opening portion without protruding into the cooling water channel.

A fourth disclosure is in accordance with any one of the first to third disclosures, wherein the cooling water channel includes an annular path that surrounds a periphery of the intake valve insertion hole, and a connecting path that connects two of the annular paths that are adjacent.

To achieve the above described objects, a fifth disclosure is a method of manufacturing a cylinder head for a multi-cylinder engine that includes: a casting mold manufacturing step of arranging a cooling water channel core for obtaining a cooling water channel inside an outer casting mold for obtaining an external shape face of a cylinder head and manufacturing a casting mold, a molten metal pouring step of pouring molten metal into the casting mold, and an extracting step of crushing the casting mold and taking out a casting. The cooling water channel core includes a core body for obtaining a cooling water channel that passes through a periphery of a plurality of intake valve insertion holes that are provided for each of a plurality of combustion chambers that are provided side by side in a longitudinal direction of the cylinder head and that extends in the longitudinal direction. The cooling water channel core also includes a core print that is formed integrally with the core body at a location that is positioned between two adjacent combustion chambers of the core body, and that contacts the outer casting mold in the casting mold manufacturing step.

A sixth disclosure is in accordance with the fifth disclosure, wherein the core print is configured so as to come in contact with a face of the other casting mold in the casting mold manufacturing step, the face of the outer casting mold for forming a face on an opposite side to a cylinder block mating face of the cylinder head.

A seventh disclosure is in accordance with the fifth or sixth disclosure, wherein the core print is arranged at a position at which a center of gravity position of the core print is on a center of gravity axis in a longitudinal direction of the core body.

An eighth disclosure is in accordance with any one of the fifth to seventh disclosures, and further includes a sealing step of sealing, by means of a sealing plug, an opening portion that is formed by transfer from the core print by the molten metal pouring step.

A ninth disclosure is in accordance with any one of the fifth to eighth disclosures, wherein in the extracting step, the casting mold is extracted from an opening portion that is formed by transfer from the core print by the molten metal pouring step.

A tenth disclosure is in accordance with any one of the fifth to ninth disclosures, wherein the cooling water channel core includes core supports that extend from both ends in the longitudinal direction; and in the casting mold manufacturing step, the core supports are arranged so as to come in contact with both end faces in the longitudinal direction of the outer casting mold.

According to the first disclosure, partway along a cooling water channel, an opening portion is provided that opens in a face on an opposite side to a side of a cylinder block mating face of a cylinder head. Therefore, according to the present disclosure, since an inspection for blockages and the like inside the cooling water channel can be performed from the opening portion, a decrease in cooling efficiency due to defects that occur during manufacture can be prevented.

According to the second disclosure, the opening portion of the cooling water channel is sealed by a sealing plug. Therefore, according to the present disclosure, the opening portion can be securely sealed after performing an inspection of the cooling water channel, and thus the leakage of cooling water can be prevented.

According to the third disclosure, because the sealing plug is configured to seal the opening portion without protruding into the cooling water channel, the opening portion can be sealed without hindering the flow of cooling water in the cooling water channel.

According to the fourth disclosure, the cooling water channel includes an annular path that surrounds the periphery of an intake valve insertion hole, and a connecting path that connects two annular paths that are adjacent. The existence or non-existence of a blockage defect in an annular path cannot be detected by a method that inspects for a blockage in a cooling water channel by applying pressure from an inlet of the channel. According to the present disclosure, even in the case of such an annular path, an inspection can be performed from the opening portion.

According to the fifth disclosure, a cooling water channel core for obtaining a cooling water channel includes: a core body for obtaining a cooling water channel that passes through a periphery of a valve insertion hole of an intake valve and extends in a longitudinal direction, and a core print that is formed integrally with the core body at a location that is positioned between an adjacent two combustion chambers of the core body and that contacts the outer casting mold in the casting mold manufacturing step. According to this core print structure, since warping and displacement of the cooling water channel core are suppressed in the molten metal pouring step, it is possible to suppress the occurrence of casting defects that are caused by displacement of the cooling water channel core and thus suppress a decrease in the cooling efficiency.

According to the sixth disclosure, when arranging the cooling water channel core inside the outer casting mold, the cooling water channel core is arranged so that the core print contacts against a face of the outer casting mold for obtaining a face on an opposite side to the cylinder block mating face of the cylinder head. Consequently, according to the present disclosure, since gas that is generated from the cooling water channel core during casting escapes to the outer casting mold through the core print without being retained at the location of the cooling water channel core, the occurrence of casting defects that are caused by gas accumulation can be suppressed.

According to the seventh disclosure, the core print is arranged so that a center of gravity position of the core print is on a center of gravity axis in a longitudinal direction of the core body. Therefore, according to the present disclosure, since rotation of the cooling water channel core due to buoyancy of the molten metal can be prevented, displacement of the cooling water channel core can be effectively suppressed.

According to the eighth disclosure, an opening portion that is formed by transfer from the core print in the molten metal pouring step can be securely sealed by a sealing plug.

According to the ninth disclosure, since an opening portion that is formed by transfer from the core print by the molten metal pouring step opens in an outer face of the cylinder head, the casting mold can be efficiently extracted from the opening portion.

According to the tenth disclosure, the cooling water channel core includes core supports that extend from both ends in the longitudinal direction, and when arranging the core inside the casting mold, the core supports are retained at both end faces in the longitudinal direction of the outer casting mold. Therefore, according to the present disclosure, displacement of the cooling water channel core can be prevented and an inlet and an outlet of a cooling water channel can be formed in end faces in the longitudinal direction of the cylinder head by the core supports.

### BRIEF DESCRIPTION OF THE DRAWINGS

FIG. 1 is a plan view of a cylinder head according to a first embodiment of the present disclosure;

FIG. 2 is a perspective view in which intake ports and a cooling water channel of the cylinder head of the first embodiment of the present disclosure are illustrated in a transparent manner;

FIG. 3 is a cross-sectional view showing a cross section along a line A-A in FIG. 1, which is a cross section that is perpendicular to the longitudinal direction that passes between two adjacent combustion chambers of the cylinder head of the first embodiment of the present disclosure;

FIG. 4 is a view for describing the structure of a sealing plug that seals an opening portion in the first embodiment of the present disclosure;

FIG. 5 is a cross-sectional view showing a cross section along the line A-A in FIG. 1, which is a cross section that is perpendicular to the longitudinal direction that passes between two adjacent combustion chambers of the cylinder head in a state in which the opening portion of the first embodiment of the present disclosure is sealed by the sealing plug;

FIG. 6 is a view showing another example of the shape of the sealing plug of the first embodiment of the present disclosure;

FIG. 7 is a perspective view, as seen from the side of a side face of the cylinder head, of the structure of a cooling water channel core for obtaining the cooling water channel of the first embodiment of the present disclosure;

FIG. 8 is a perspective view, as seen from the center side of the cylinder head, of the structure of the cooling water channel core for obtaining the cooling water channel of the first embodiment of the present disclosure;

FIG. 9 is a view for describing the manner in which the cooling water channel core of the first embodiment of the present disclosure is incorporated into an outer casting mold;

FIG. 10 is a perspective view in which intake ports and a cooling water channel of a cylinder head as a modification of the first embodiment of the present disclosure are illustrated in a transparent manner; and

FIG. 11 is a perspective view in which intake ports and a cooling water channel of a cylinder head as another modification of the first embodiment of the present disclosure are illustrated in a transparent manner.

### DETAILED DESCRIPTION OF THE PREFERRED EMBODIMENT

Embodiments will now be described referring to the accompanying drawings. However, the embodiments described hereunder exemplify an apparatus and a method for materializing the technical concept of the present disclosure, and except where otherwise expressly stated, it is not intended to limit the structures and arrangements of the constituent components and the order of processes and the like to those described hereunder. The present disclosure is not limited to the embodiments described hereunder, and various modifications can be made within a range that does not depart from the gist of the present disclosure.

### First Embodiment

Hereunder, a first embodiment of the present disclosure is described using the accompanying drawings. The description of the first embodiment is based on the premise that the engine is a spark-ignition type, water-cooled in-line four-cylinder engine. Cooling water for cooling the engine is circulated between the engine and a radiator by a circulation system. The engine includes a cylinder block, and a cylinder head that is mounted on the cylinder block via a gasket. Cooling water is supplied to both of the cylinder block and the cylinder head. The circulation system is an independent closed loop, and includes the radiator and a water pump. However, when applying the present disclosure to an engine, the number of cylinders and the layout of cylinders of the engine as well as the ignition system of the engine are not limited as long as the engine is a multi-cylinder engine. Further, the circulation system may be configured as a multi-line circulation system that includes a plurality of independent closed loops.

### <Basic Configuration of Cylinder Head of First Embodiment>

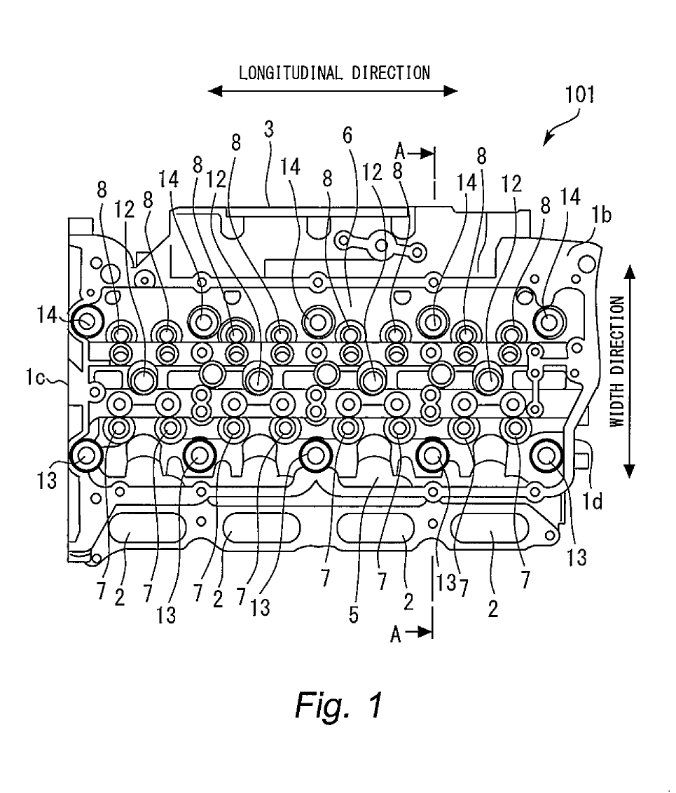

Hereunder, the basic configuration of a cylinder head 101 of the first embodiment will be described referring to FIG. 1 to FIG. 4. A plan view and a cross-sectional view of the cylinder head 101 will be used to facilitate the following description. Four intake ports 2 that correspond to four cylinders are formed in the cylinder head 101. Note that, hereinafter in the present specification, unless expressly stated otherwise, the positional relationship between the respective components will be described based on the assumption that the cylinder head 101 is positioned on the upper side in the vertical direction with respect to the cylinder block. This assumption is made merely to facilitate understanding of the description, and this assumption is not intended to add any kind of restrictive meaning with respect to the configuration of the cylinder head according to the present disclosure. Among the portions constituting the cylinder head 101, the configuration of a cooling water channel will be described in detail later.

### <<Basic Configuration of Cylinder Head as Seen in a Plan View>>

FIG. 1 is a plan view of the cylinder head 101 of the first embodiment. More specifically, FIG. 1 is a plan view in which the cylinder head 101 is seen from the side of a head cover mounting face 1b to which a head cover is mounted. Hence, in FIG. 1, a cylinder block mating face 1a, that is a rear face, cannot be seen in this figure. Note that, in the present specification, the axial direction of a crankshaft is defined as the longitudinal direction of the cylinder head 101, and a direction that is orthogonal to the longitudinal direction and is parallel to the cylinder block mating face 1a of the cylinder head 101 is defined as the width direction of the cylinder head 101. Further, among end faces 1c and 1d in the longitudinal direction, the end face 1d that is on the side of an output end of the crankshaft is referred to as “rear end face”, and the end face 1c that is on the opposite side thereto is referred to as “front end face”. Further, the cylinder block mating face 1a is defined as a flat surface that is perpendicular to the central axis of the respective cylinders of the cylinder block in a case where the cylinder head 101 is attached to the cylinder block.

The cylinder head 101 of the first embodiment is a cylinder head of a spark-ignition type in-line four cylinder engine. Although not shown in FIG. 1, four combustion chambers for four cylinders are formed side by side at regular intervals in a line in the longitudinal direction on the lower face (mating face 1a with respect to the cylinder block) of the cylinder head 101. Spark plug insertion holes 12 are provided for each of the plurality of combustion chambers in the cylinder head 101.

The intake ports 2 and exhaust ports 3 are formed in a side face of the cylinder head 101. Specifically, each of the intake ports 2 opens in a right side face of the cylinder head 101 as seen from the side of the front end face 1c, and each of the exhaust ports 3 opens in a left side face. In the present specification, hereinafter, a side face that is located on the right side when the cylinder head 101 is viewed from the side of the front end face 1c is referred to as the “right side face” of the cylinder head 101, and a side face that is located on the left side is referred to as the “left side face” of the cylinder head 101. The intake ports 2 extend from the respective combustion chambers, and the respective intake ports 2 independently open in the right side face of the cylinder head 101. The exhaust ports 3 merge into a single exhaust port inside the cylinder head 101, and the single exhaust port 3 into which the respective exhaust ports 3 merge opens in the left side face of the cylinder head 101. Hence, in the present specification, the right side when the cylinder head 101 is viewed from the side of the front end face 1c may be referred to as “intake side”, and the left side may be referred to as “exhaust side”.

The cylinder head 101 of the first embodiment is a cylinder head of a four-valve engine in which two intake valves and two exhaust valves are provided for each cylinder. In the upper face of the cylinder head 101, two intake valve insertion holes 7 and two exhaust valve insertion holes 8 are formed so as to surround a single spark plug insertion hole 12. The intake valve insertion holes 7 are connected with the intake ports 2 inside the cylinder head 101, and the exhaust valve insertion holes 8 are connected with the exhaust ports 3 inside the cylinder head 101.

An intake-side valve mechanism chamber 5 that houses a valve mechanism that actuates the intake valves is provided on an inner side of the head cover mounting face 1b, that is the upper face of the cylinder head 101. Cylinder head bolt insertion holes 13 are formed on the intake side in the vertically downward direction from the intake-side valve mechanism chamber 5 in the cylinder head 101. Further, an exhaust-side valve mechanism chamber 6 that houses a valve mechanism that actuates the exhaust valves is provided on an inner side of the head cover mounting face 1b, that is the upper face of the cylinder head 101. Cylinder head bolt insertion holes 14 are formed on the intake side in the vertically downward direction from the exhaust-side valve mechanism chamber 6 in the cylinder head 101.

### <<Configuration of Cooling Water Channel of Cylinder Head of First Embodiment>>

Next, the configuration of the cooling water channel of the cylinder head 101 of the first embodiment will be described. A cross-sectional view of the cylinder head 101 and a perspective view in which the cooling water channel inside the cylinder head 101 are illustrated in a transparent manner will be used to facilitate the following description.

### <Basic Configuration of Cooling Water Channel of Cylinder Head of First Embodiment>

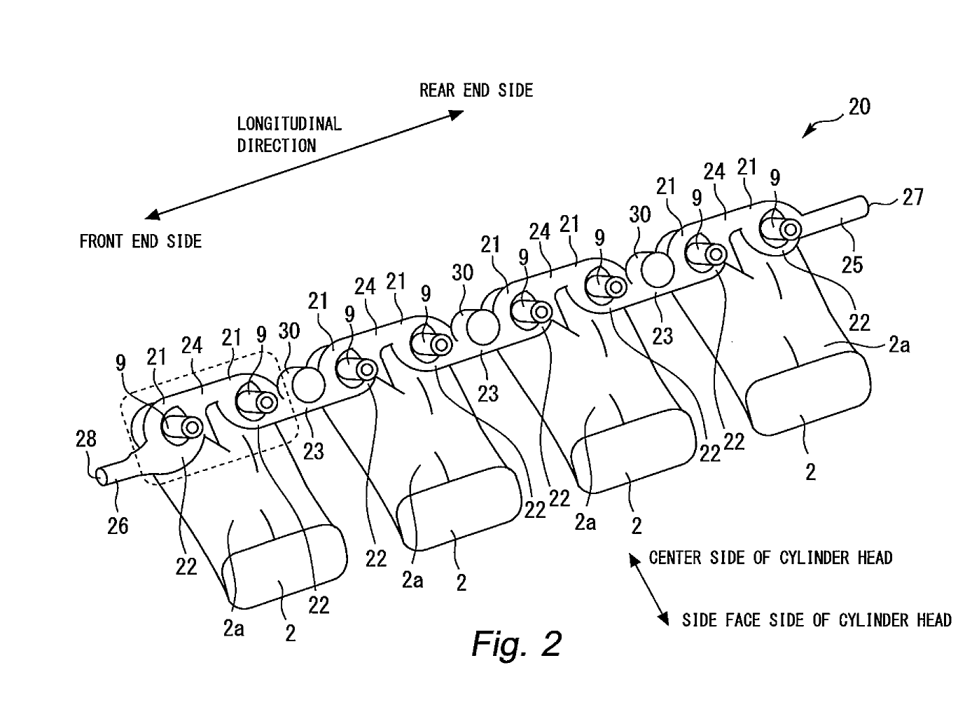

The basic shape of the cooling water channel of the cylinder head of the first embodiment will be described using FIG. 2. FIG. 2 is a perspective view in which the intake ports 2 and a cooling water channel 20 of the cylinder head of the first embodiment are illustrated in a transparent manner. The shape of the cooling water channel 20 and the positional relation between the cooling water channel 20 and the intake ports 2 as seen when the inside of the cylinder head is shown in a transparent manner are illustrated in FIG. 2.

The cooling water channel 20 is provided on an upper side of the row of intake ports 2 inside the cylinder head. The cooling water channel 20 extends in the direction of the row of intake ports 2, that is, the longitudinal direction of the cylinder head, along an upper face 2a of the respective intake ports 2.

The cooling water channel 20 has a unit structure for each intake port 2. In FIG. 2, a structure of a portion that is surrounded by a dashed line is the unit structure of the cooling water channel 20. The unit structure includes a pair of annular paths arranged at the periphery of respective valve guides 9 (more exactly, intake valve insertion holes) at the left and right of the relevant intake port 2. Each annular path is constituted by an inner channel 21 that is positioned on the center side of the cylinder head relative to the valve guides 9, and an outer channel 22 that is positioned on the side face side of the cylinder head relative to the valve guides 9. The inner channel 21 and the outer channel 22 each curve in an arc shape, and are axially symmetric with respect to the corresponding valve guide 9. The channel cross-sectional areas of the inner channel 21 and the outer channel 22 are approximately equal to each other.

The unit structure includes a first connecting path 24 that connects the left and right annular paths forming the inner channel 21 and the outer channel 22. The first connecting path 24 is positioned on the center side of the cylinder head relative to the valve guides 9, which is a position at an upper portion of a space between branch ports at the left and right of the intake port 2. The first connecting path 24 is a channel that extends in the longitudinal direction and is continuously connected to the left and right inner channels 21. In this case, the term “continuously connected” refers to a fact that the flow direction of the inner channel 21 and the flow direction of the first connecting path 24 correspond at a connecting position between the inner channel 21 and the first connecting path 24. The outer channel 22 is connected to the connecting position between the inner channel 21 and the first connecting path 24.

The cooling water channel 20 includes a second connecting path 23 that connects two adjacent unit structures. The second connecting path 23 is positioned on the side face side of the cylinder head relative to the valve guides 9, which is a position at an upper part of the space between two adjacent intake ports 2. The second connecting path 23 is a channel that extends in the longitudinal direction and is continuously connected to the outer channels 22 of two adjacent unit structures. The inner channel 21 is connected to a connecting position between the outer channel 22 and the second connecting path 23. In the cooling water channel 20, the first connecting paths 24 that are positioned on the center side of the cylinder head relative to the valve guides 9, and the second connecting paths 23 that are positioned on the side face side of the cylinder head relative to the valve guides 9 are alternately arranged in the longitudinal direction in a manner that sandwiches the respective annular paths constituted by the inner channel 21 and the outer channel 22 therebetween.

An inlet channel 25 and an outlet channel 26 are provided at the two end portions in the longitudinal direction of the cooling water channel 20. The inlet channel 25 extends in a straight line in the longitudinal direction from an annular path that is nearest the rear end of the cylinder head to a rear end face of the cylinder head, and communicates with a first hole 27 formed in the rear end face. The first hole 27 is a cooling water inlet that is formed in the cylinder head. The outlet channel 26 extends in a straight line in the longitudinal direction from an annular path that is nearest the front end of the cylinder head to a front end face of the cylinder head, and communicates with a second hole 28 opened in the front end face. The second hole 28 is a cooling water outlet that is formed in the cylinder head. Note that a configuration can also be adopted so that, by utilizing the second hole 28 as the cooling water inlet and utilizing the first hole 27 as the cooling water outlet, cooling water is introduced from the front end side of the cylinder head and the cooling water is discharged from the rear end side.

The cooling water enters the cooling water channel 20 from the first hole 27 as a cooling water inlet, passes through the inside of the cooling water channel 20, and thereafter flows out from the second hole 28 as a cooling water outlet. During the course of entering and flowing out from the cooling water channel 20, the cooling water flows through the annular paths that surround the valves guide 9 (more exactly, intake valve insertion holes). The channel cross-sectional areas of the inner channel 21 and the outer channel 22 constituting the respective annular paths are approximately equal, and the channel lengths from the first connecting path 24 (or second connecting path 23) to the second connecting path 23 (or first connecting path 24) are approximately equal in the case of passing through the inner channel 21 and the case of passing through the outer channel 22. Consequently, since the cooling water flows equally in both the inner channel 21 and the outer channel 22 in the annular paths, retention of cooling water does not occur along the cooling water channel 20.

### <Characteristic Configuration of Cooling Water Channel of Cylinder Head of First Embodiment>

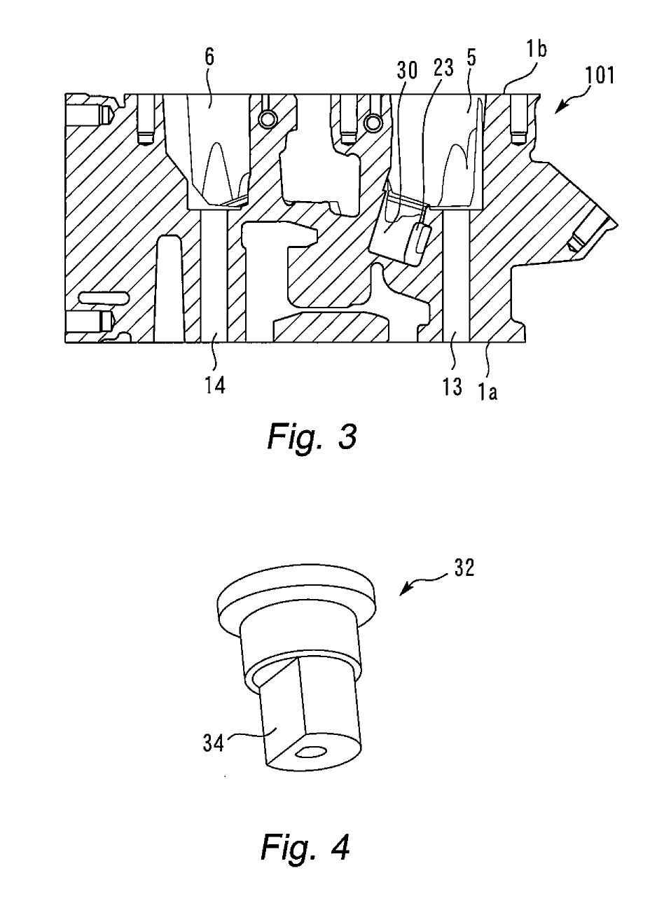

Next, a characteristic shape of the cooling water channel of the cylinder head of the first embodiment will be described with reference to FIG. 3 also. FIG. 3 is a cross-sectional view illustrating a cross section (cross section A-A in FIG. 1) that is perpendicular to the longitudinal direction that passes between two adjacent combustion chambers of the cylinder head 101. As shown in FIG. 2 and FIG. 3, an opening portion 30 that opens into the intake-side valve mechanism chamber 5 is provided in the second connecting path 23 of the cooling water channel 20. When manufacturing the cylinder head 101 by casting, the cooling water channel 20 is formed by transfer inside the cylinder head using a core that is formed of sand. The opening portion 30 is a portion obtained as a result of a column-shaped core print that is provided in the core being formed by transfer. Note that details regarding the method of manufacturing the cylinder head 101 and the shape of the core are described later.

In the case of a cooling water channel that is formed in an elongated shape in the longitudinal direction, as in the case of the cooling water channel 20, there is a concern that extraction of sand that is performed after casting will be inadequate and the channel will become blocked. In the cooling water channel 20 of the first embodiment, because the opening portion 30 is formed in the second connecting path 23, it is possible to efficiently extract sand from the opening portion 30. Further, the opening portion 30 can be utilized as an inspection opening for performing an inspection to check for blockage of the channel and an inspection to determine whether or not there is a casting defect. In particular, since a blockage of an annular path cannot be discovered by a common inspection that checks for the presence or absence of a blockage by applying pressure from an inlet, the utility value of the opening portion 30 as an inspection opening is significant.

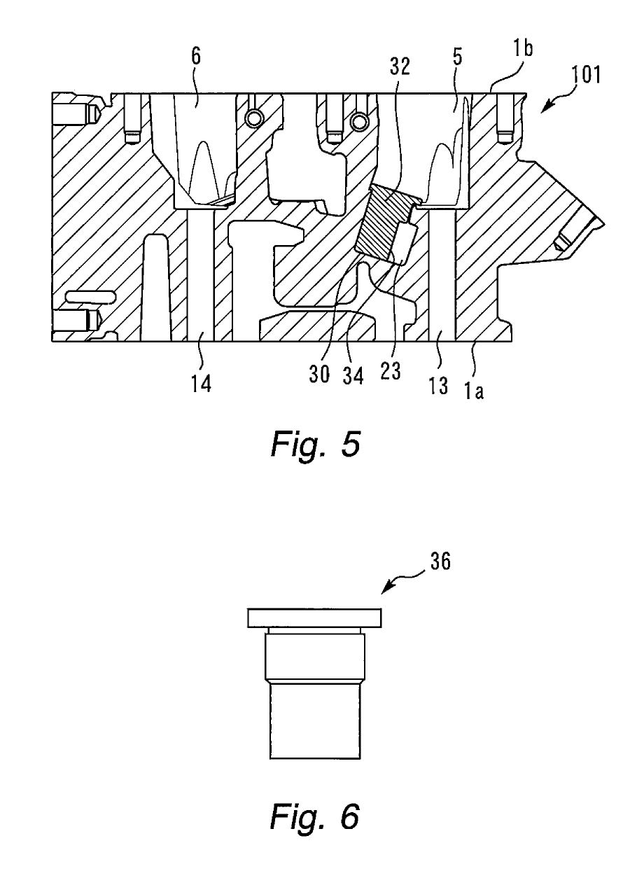

Note that the opening portion 30 is sealed after being utilized as a sand extraction opening and an inspection opening. FIG. 4 is a view for describing the structure of a sealing plug that seals the opening portion 30. Further, FIG. 5 is a cross-sectional view along a cross section (cross section A-A in FIG. 1) that is perpendicular to the longitudinal direction that passes between two adjacent combustion chambers of the cylinder head 101 in a state in which the opening portion 30 is sealed by the sealing plug. As shown in FIG. 4, the sealing plug 32 is formed in a stepped cylindrical shape, and a flat surface portion 34 for ensuring the sealing plug 32 does not protrude into the cooling water channel 20 is formed in a cylindrical portion at the end of the sealing plug 32. The sealing plug 32 is fixed after performing positioning so that the flat surface portion 34 is oriented facing the second connecting path 23. Note that, a height in the cylindrical axis direction of the sealing plug 32 is set such that the end portion of the sealing plug 32 contacts an end face on the cylinder block mating face 1a side of the opening portion 30 when the sealing plug 32 is fixed in the opening portion 30. According to this shape of the sealing plug 32, since the sealing plug 32 does not protrude into the second connecting path 23, the channel cross-sectional area of the second connecting path 23 is maintained.

Note that as long as the shape of the sealing plug is a shape that does not completely block the second connecting path 23 while also sealing the opening to the intake-side valve mechanism chamber 5, the shape of the sealing plug need not necessarily be the same as the shape of the sealing plug 32. FIG. 6 is a view that illustrates another example of the shape of the sealing plug. A sealing plug 36 illustrated in FIG. 6 has a similar structure to the sealing plug 32 except that the sealing plug 36 does not include the flat surface portion 34 that is shown in FIG. 5. Although the channel cross-sectional area of the second connecting path 23 will become somewhat narrower when the sealing plug 36 is used, use of the sealing plug 36 can be expected to improve the workability in the respect that positioning of the sealing plug 36 in the rotational direction is not required.

### <<Method of Manufacturing Cooling Water Channel of Cylinder Head of First Embodiment>>

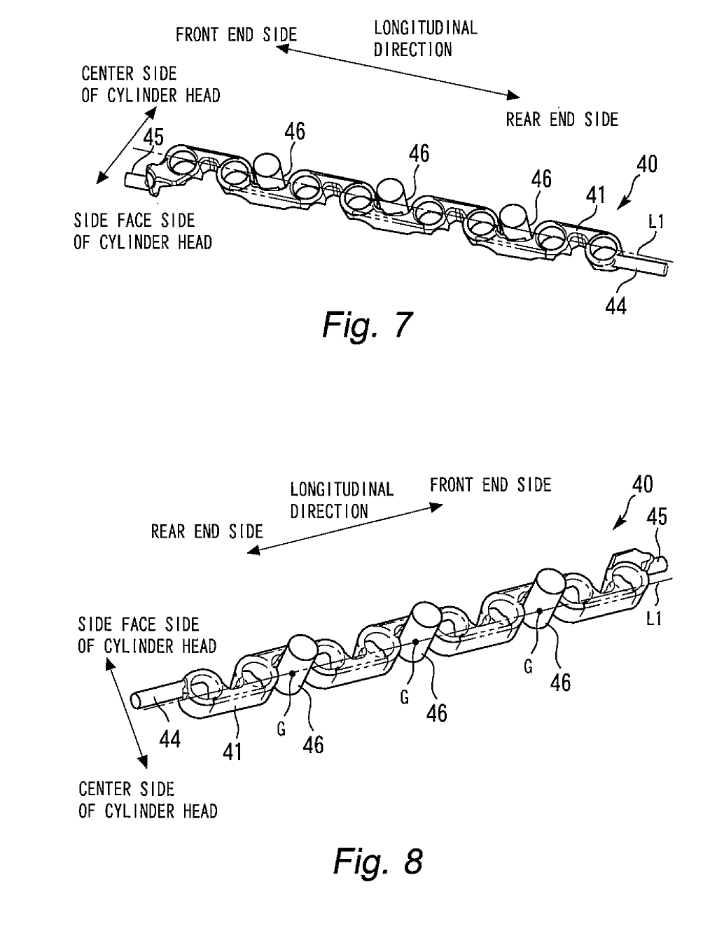

Next, a method of manufacturing the cylinder head 101 of the first embodiment will be described using FIG. 7 to FIG. 9. The cylinder head 101 of the first embodiment is manufactured by cast molding. A process for molding a casting by cast molding includes a casting mold manufacturing step of manufacturing a casting mold that includes a core, a molten metal pouring step of pouring molten metal into the casting mold, and an extracting step of crushing the casting mold and taking out a casting. According to the method of manufacturing the cylinder head 101 of the first embodiment, in the casting mold manufacturing step, a sand core for obtaining the cooling water channel 20 is arranged inside an outer casting mold for forming the outer shape of the cylinder head 101, and manufacturing of the casting mold of the cylinder head 101 is performed. Note that, the term “outer casting mold” used here refers to a casting mold having a face for forming an external shape face of the cylinder head 101, and it does not matter whether the casting mold is an outer mold or a core. In the subsequent molten metal pouring step, pouring of molten metal into the manufactured casting mold is performed. Next, in the extracting step, the cylinder head 101 is manufactured as a casting by crushing the casting mold and extracting sand from the inside thereof

A feature of the method of manufacturing the cylinder head of the first embodiment is the structure of the cooling water channel core for obtaining the cooling water channel 20. FIG. 7 is a perspective view, as seen from the side of a side-face of the cylinder head, of the structure of the cooling water channel core for obtaining the cooling water channel 20. FIG. 8 is a perspective view, as seen from the center side of the cylinder head, of the structure of the cooling water channel core for obtaining the cooling water channel 20

As shown in FIG. 7 and FIG. 8, a cooling water channel core 40 includes annular paths (that is, the inner channel 21 and the outer channel 22) of the cooling water channel 20, and a core body 41 for obtaining the first connecting path 24 and the second connecting path 23. Note that since the shape and arrangement of the core body 41 is the same as the shape and arrangement of the annular paths (that is, the inner channel 21 and the outer channel 22) of the cooling water channel 20 and the first connecting path 24 and second connecting path 23, a description thereof is omitted here.

Core supports 44 and 45 are provided at an end part on the rear end side and an end part on the front end side in the longitudinal direction of the cooling water channel core 40, respectively. The core supports 44 and 45 support the cooling water channel core 40 from both sides. The core supports 44 and 45 are supported by faces of an outer casting mold forming the end faces 1c and 1d in the longitudinal direction of the cylinder head 101 in the casting mold manufacturing step. The inlet channel 25 and outlet channel 26 of the cylinder head 101 are channels formed by the core supports 44 and 45 that support the cooling water channel core 40 from both sides. The first hole 27 and second hole 28 are sand extraction holes that are formed by removing the core supports 44 and 45. That is, in the cylinder head of the first embodiment, sand extraction holes that are made when forming the cooling water channel 20 by means of the cooling water channel core 40 are utilized as a cooling water inlet and a cooling water outlet.

Further, a core print 46 is integrally provided at each location between adjacent combustion chambers of the core body 41, that is, at each location for obtaining the second connecting path 23 of the core body 41. Each core print 46 is formed in a cylindrical column shape, and a central axis thereof faces in a direction that is parallel to the central axis direction of a portion for obtaining an annular path of the core body 41. Each core print 46 is arranged at a position at which a center of gravity position G thereof is located on a center of gravity axis L1 that extends in the longitudinal direction of the core body 41. According to this configuration, it is possible to effectively suppress the occurrence of a situation in which the cooling water channel core 40 rotates due to the buoyancy of molten metal at the time of the molten metal pouring step. Further, although insufficient strength is a concern because the core body 41 is an elongated shape in the longitudinal direction, integration of the core prints 46 makes it possible to enhance the strength.

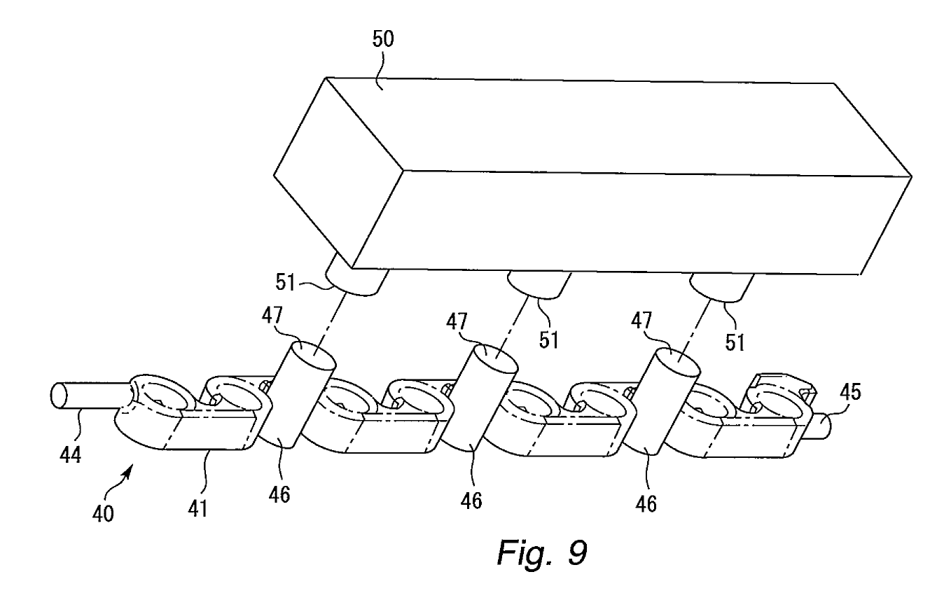

In the casting mold manufacturing step, each core print 46 is arranged so that an end face 47 on the upper side thereof contacts a surface of the outer casting mold. FIG. 9 is a view for describing the manner in which the cooling water channel core 40 is incorporated into the outer casting mold. As shown in FIG. 9, the outer casting mold 50 is a sand mold or a metal mold that is formed as a core or an outer mold, and is a casting mold that includes a face for forming a face on an opposite side to a cylinder block mating face 1a of the cylinder head 101, more specifically, a face of the intake-side valve mechanism chamber 5. When the cooling water channel core 40 is arranged inside the outer casting mold 50, the end face 47 on the upper side of each core print 46 contacts against a contact surface 51 of the outer casting mold 50. A core that is formed in an elongated intricate shape, such as the cooling water channel core 40 of the first embodiment, is liable to be lifted upward by the buoyancy of the molten metal in the molten metal pouring step or to be displaced due to warping of the core itself. According to the configuration of the cooling water channel core 40 of the first embodiment, because each core print 46 is arranged in contact with the corresponding contact surface 51 of the outer casting mold 50 in the casting mold manufacturing step, warping and displacement of the cooling water channel core 40 in the molten metal pouring step can be effectively suppressed. Since the dimensional accuracy of the cooling water channel 20 is improved if displacement of the cooling water channel core 40 can be suppressed in this manner, it also becomes possible to adopt a design that narrows a clearance between the cooling water channel 20 and adjacent spaces, and thus the cooling efficiency can be improved.

Further, according to the configuration of the cooling water channel core 40 of the first embodiment, since the core prints 46 are arranged in contact with the contact surfaces 51 of the outer casting mold 50 in the casting mold manufacturing step, gas that is produced from the cooling water channel core 40 in the molten metal pouring step moves from the core print 46 to the outer casting mold 50 on the vertically upward side thereof. By this means, the retention of gas in the cooling water channel core 40 can be prevented, and thus the occurrence of casting defects can be suppressed.

According to the configuration of the cooling water channel core 40 of the first embodiment, the opening portions 30 in the cylinder head 101 are formed by the core prints 46 of the cooling water channel core 40. Since each opening portion 30 can be utilized as a hole for extracting sand in the extracting step, the occurrence of a defect in which the cooling water channel 20 is blocked by residual sand can be effectively prevented.

Furthermore, after the extracting step ends, an inspection step of inspecting for blockages in the cooling water channel 20 may be performed. At such time, the opening portions 30 can also be utilized as inspection openings for inspecting for blockages in the cooling water channel 20. After the extracting step and, where necessary, an inspection step, have been completed, a sealing step of sealing the opening portion 30 is performed. In this case, the above described sealing plug 32 is mounted in the opening portion 30.

Thus, according to the method of manufacturing the cylinder head 101 of the first embodiment, it is possible to manufacture a cylinder head having excellent cooling efficiency and in a manner in which the occurrence of casting defects is suppressed.

In this connection, although in the above described first embodiment a configuration is adopted in which the core prints 46 are provided at all the locations (three places) that are between two adjacent combustion chambers of the core body 41, a configuration may also be adopted in which only any one of the core prints 46 is provided. Further, the shape of the core print 46 is not limited to a cylindrical column shape and may be a different shape as long as the shape is one that includes a face that contacts against the contact surface 51 of the outer casting mold 50.

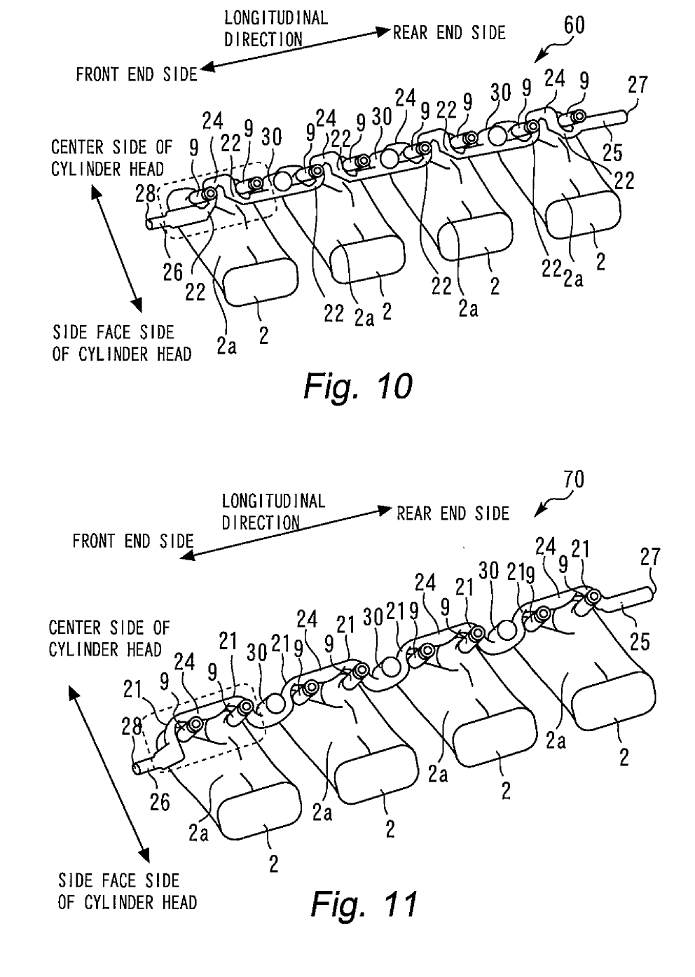

Although in the above described first embodiment a shape that covers the periphery of the respective valve guides 9 in an annular shape is adopted as the shape of the cooling water channel 20, a channel shape that can be implemented in the present disclosure is not limited thereto. That is, a different shape may be adopted as long as the channel shape is one that extends in the longitudinal direction in a manner that passes through the periphery of the plurality of valve guides 9 that are provided for each of the plurality of combustion chambers. FIG. 10 is a perspective view in which the intake ports 2 and a cooling water channel 60 of a cylinder head as a modification are illustrated in a transparent manner. The cooling water channel 60 illustrated in FIG. 10 has the same structure as the cooling water channel 20 of the first embodiment with the exception that, relative to the cooling water channel 20 of the first embodiment, the inner channel 21 is removed from the annular paths. According to this channel structure, a channel that passes through the periphery of the valve guides 9 is configured as a channel that passes through the center side of the cylinder head relative to the valve guides 9. Further, FIG. 11 is a perspective view in which the intake ports 2 and a cooling water channel 70 of a cylinder head as another modification are illustrated in a transparent manner. The cooling water channel 70 illustrated in FIG. 11 has the same structure as the cooling water channel 20 of the first embodiment with the exception that, relative to the cooling water channel 20 of the first embodiment, the outer channel 22 is removed from the annular paths. According to this channel structure, a channel that passes through the periphery of the valve guides 9 is configured as a channel that passes through the side face side of the cylinder head relative to the valve guides 9. Thus, according to the structures of the cooling water channels 60 and 70 shown in FIG. 10 and FIG. 11, gas that flows through the intake ports can be efficiently cooled in a similar manner to the cooling water channel 20.

1. A cylinder head for a multi-cylinder engine, comprising:
a plurality of combustion chambers that are provided side by side in a longitudinal direction of the cylinder head;
a plurality of intake valve insertion holes that are provided for each of the plurality of combustion chambers; and
a cooling water channel that passes through a periphery of the plurality of intake valve insertion holes and extends in the longitudinal direction;
wherein, in at least at one cross section among cross sections that are perpendicular to the longitudinal direction between two adjacent combustion chambers, the cylinder head includes an opening portion that opens in a face on an opposite side to a cylinder block mating face of the cylinder head from the cooling water channel.

2. The cylinder head according to claim 1, wherein the opening portion is sealed by a sealing plug.

3. The cylinder head according to claim 2, wherein the sealing plug is configured to seal the opening portion without protruding into the cooling water channel.

4. The cylinder head according to claim 1, wherein the cooling water channel includes an annular path that surrounds the periphery of the intake valve insertion hole, and a connecting path that connects two of the annular paths that are adjacent.

5. A method of manufacturing a cylinder head for a multi-cylinder engine that includes: a casting mold manufacturing step of arranging a cooling water channel core for obtaining a cooling water channel inside an outer casting mold for obtaining an external shape face of a cylinder head and manufacturing a casting mold, a molten metal pouring step of pouring molten metal into the casting mold, and an extracting step of crushing the casting mold and taking out a casting;
wherein the cooling water channel core comprises:
a core body for obtaining a cooling water channel that passes through a periphery of a plurality of intake valve insertion holes that are provided for each of a plurality of combustion chambers that are provided side by side in a longitudinal direction of the cylinder head and the core body extends in the longitudinal direction; and
a core print that is formed integrally with the core body at a location that is positioned between two adjacent combustion chambers of the core body, and that contacts the outer casting mold in the casting mold manufacturing step.

6. The method of manufacturing a cylinder head according to claim 5, wherein the core print is configured so as to come in contact with a face of the outer casting mold in the casting mold manufacturing step, the face of the outer casting mold for forming a face on an opposite side to a cylinder block mating face of the cylinder head.

7. The method of manufacturing a cylinder head according to claim 5, wherein the core print is arranged at a position at which a center of gravity position of the core print is on a center of gravity axis in a longitudinal direction of the core body.

8. The method of manufacturing a cylinder head according to claim 5, further comprising a sealing step of sealing, by means of a sealing plug, an opening portion that is formed by transfer from the core print by the molten metal pouring step.

9. The method of manufacturing a cylinder head according to claim 5, wherein, in the extracting step, the casting mold is extracted from an opening portion that is formed by transfer from the core print by the molten metal pouring step.

10. The method of manufacturing a cylinder head according to claim 5, wherein,
the cooling water channel core comprises core supports that extend from both ends in the longitudinal direction; and
in the casting mold manufacturing step, the core supports are arranged so as to come in contact with both end faces in the longitudinal direction of the outer casting mold.
